(19) United States
(12) Patent Application Publication
(10) Pub. No.: US 2011/0320983 A1
(43) Pub. Date: Dec. 29, 2011

(54) METHOD AND SYSTEM FOR CONTROLLING STEREOSCOPIC MENU DISPLAY, AND MOBILE COMMUNICATION TERMINAL

(75) Inventors: Shaojun Chen, Shenzhen (CN); Guojun Wang, Shenzhen (CN); Xu'an Li, Shenzhen (CN); Wei Gao, Shenzhen (CN)

(73) Assignee: SHENZHEN COSHIP ELECTRONICS CO. LTD., Shenzhen (CN)

(21) Appl. No.: 13/142,276

(22) PCT Filed: Dec. 30, 2009
(86) PCT No.: PCT/CN2009/076250

§ 371 Date: Jun. 24, 2011

(30) Foreign Application Priority Data
Jan. 13, 2009 (CN) 200910104985.1

(51) Int. Cl. G06F 3/048

(52) U.S. Cl. 715/836

(57) ABSTRACT

A method and system for controlling stereoscopic menu display and a mobile communication terminal are provided. Wherein, the method includes: generating and displaying a stereoscopic menu including icons; obtaining a moving track inputted by a user; determining the corresponding rotation tangent planes, rotation directions and rotation speed of the icons in the stereoscopic menu according to coordinates of various points; controlling each icons in the stereoscopic menu to rotate in rotation direction at the rotation speed on the corresponding rotation tangent planes; detecting whether a recovery signal inputted by the user is received, if yes, controlling the stereoscopic menu recovery display according to the icon recovery signal. The present invention, which is based on the moving track inputted on an interface including the stereoscopic menu displayed in an external display unit by the user, determines the rotation tangent planes and rotation direction of each icons in the stereoscopic menu, and controls each icons in the stereoscopic menu to rotate in the determined, rotation directions on the determined corresponding rotation tangent planes respectively, thus enabling a flexible, variable and fun interface display.

This application claims the priority to Chinese Patent Application No. 200910104985.1, filed with the Chinese Patent Office on Jan. 13, 2009 and entitled “A Method and System for Controlling Stereoscopic Menu Display and Mobile Communication Terminal”, which is hereby incorporated by reference in its entirety.

### TECHNOLOGY FIELD

The present invention relates to a display technology, particularly to a method and system for controlling stereoscopic menu and a mobile communication terminal.

### BACKGROUND TECHNOLOGIES

Currently, the menu interface of a mobile communication terminal mainly lists the basic functions offered by the terminal for users to browse, and provides users with access to a specific basic function. In the prior art, basic functions provided in the menu interface are mostly shown through simple grids or lists, both of which fall in the two-dimensional category, as no stereoscopic solutions are currently available for menu presentation.

### CONTENTS OF THE INVENTION

The objective of the embodiments of the present invention is to provide a method for controlling stereoscopic menu display, aiming at coping with problems due to the lack of solutions for displaying the menu interface in a stereoscopic manner based on the prior art. The embodiments of the invention provide a method for controlling stereoscopic menu display in steps, comprising:
Generating and displaying the stereoscopic menu that contains icons;
Obtaining the moving track inputted by the user on the interface that contains the stereoscopic menu;
Determining the rotation tangent planes and rotation direction of the icons in the stereoscopic menu along the coordinates of at least two points on the moving track; and
Controlling the icons in the stereoscopic menu to rotate in their corresponding rotation tangent planes and at the said rotation speed along the said rotation direction.

Another objective of the embodiments of the invention is to provide a system for controlling stereoscopic menu display, comprising:
Stereoscopic Menu Generating Unit, configured to generate the stereoscopic menu that contains icons and having it displayed via the external display unit;
User Gesture Acquiring Unit, configured to acquire the moving track inputted by the user on the interface that contains the stereoscopic menu generated by the Stereoscopic Menu Generating Unit; and
Rotation Display Control Unit, configured to determine the rotation tangent planes and rotation direction of the icons in the stereoscopic menu generated by the Stereoscopic Menu Generating Unit according to the coordinates of at least two points on the moving track acquired by the User Gesture Acquiring Unit, and control the icons in the stereoscopic menu as displayed via the external display unit to rotate in their corresponding rotation tangent planes along the determined rotation direction.

A further objective of the embodiments of the invention is to provide a mobile communication terminal, comprising a system and touch screen configured to control stereoscopic menu display, wherein the said system is the same as the foregoing.

In the embodiments of the invention, based on the moving track inputted by the user on the interface that contains the stereoscopic menu as displayed via the external display unit, the unit is configured to determine rotation tangent planes and rotation direction of the icons in the stereoscopic menu. These icons in the stereoscopic menu are controlled to rotate in their corresponding rotation tangent planes along the determined rotation direction, thereby enabling a flexible, diversified and fun-packed interface display.

### BRIEF DESCRIPTION OF THE DRAWINGS

FIG. 1 illustrates the processes for implementing the method for controlling stereoscopic menu display as provided in the embodiments of the invention;

FIG. 2 illustrates the principles for enabling the system for controlling stereoscopic menu display as provided in the embodiments of the invention;

FIG. 3 illustrates the structure of FIG. 2 as provided in an embodiment of the invention; and

FIG. 4 illustrates the structure of FIG. 2 as provided in another embodiment of the invention.

### DETAILED DESCRIPTION OF THE EMBODIMENTS

To clarify the objectives, technical schemes, and advantages of the present invention, the following sections detail the present invention based on the accompanying drawings and embodiments. It is understandable that the embodiments described herein are intended only to illustrate and not to limit this invention.

In the embodiments of the invention, based on the moving track inputted by the user on the interface, comprising the stereoscopic menu as displayed via the external display unit, which is configured to determine the rotation tangent planes and rotation direction of the icons in the stereoscopic menu. These icons in the stereoscopic menu are controlled to rotate in their corresponding rotation tangent planes and at the determined speed along the determined rotation direction.

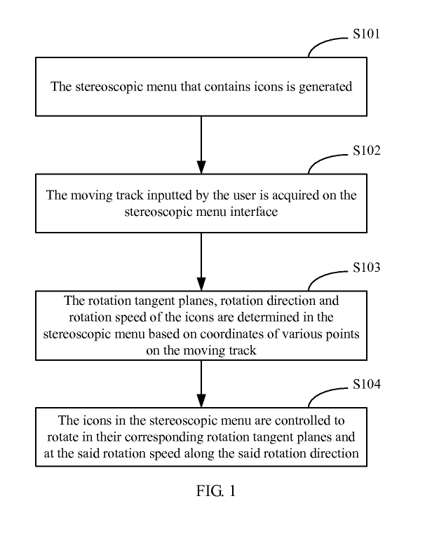

FIG. 1 illustrates the processes for implementing the method for controlling stereoscopic menu display as provided in the embodiments of the invention.

In Step S101, a stereoscopic menu containing icons is generated and displayed. The icons herein can be images or words indicating specific functions; the stereoscopic menu that contains icons refers to some stereoscopic graphics that contain various menu icons indicating the basic functions provided by the primary interface, such as spheres and other regular stereoscopic graphics. In some embodiments, the stereoscopic menu can also comprise icons provided by a plurality of secondary or below interfaces.

In the embodiment of the invention, steps used to generate a stereoscopic menu that contains icons comprise:
locating the focus of the stereoscopic menu;
specifying the boundary to confine the stereoscopic menu with the determined focus being its centre; and
distributing the icons on or within the boundary.

For example, when the stereoscopic menu is shown as a sphere, its focus will be the centre of the sphere, and its boundary will be the circumference of the sphere's tangent circle that intersects with the centre of the sphere and runs parallel to the interface as displayed via the external display unit, and further, when the stereoscopic menu is shown as a cube, its focus will be the centre of the cube, and its boundary will be each of the cube's sides; recording and storing coordinates of the boundary and those of the distributed icons, wherein the focus of the stereoscopic menu herein is not limited to any point on the interface as displayed via the external display unit; in the present embodiment of the invention, the focus of the stereoscopic menu should be the centre of the interface as displayed via the external display unit. Moreover, the focus and the boundary are transparent to the user. Specifically, they do not show up on the interface that contains the stereoscopic menu.

After the icons are distributed on or within the defined boundary, the embodiment of the invention also allows one more step in order to display the stereoscopic menu in a more visual manner: setting the attributes of the distributed icons comprising their sizes, colors, brightness and transparency, so that icons in different layers of the stereoscopic menu are differentiated. For example, icons visible to users in the stereoscopic menu can be differentiated from those invisible by assigning distinct attributes to them. It is preferable to make icons visible to users in the stereoscopic menu larger, brighter and less transparent than those invisible; furthermore, icons invisible to users in the stereoscopic menu can also be assigned more attributes in order to make them different from one another in different layers of the stereoscopic menu, thereby creating a more vivid stereoscopic graphic.

In another embodiment of the invention, steps to generate a stereoscopic menu that contains icons comprise:
locating the focus of the stereoscopic menu;
specifying the boundary to confine the stereoscopic menu with the determined focus being its centre;
determining a plurality of tracks, which may run parallel or vertical to or intersect with one another, within the defined boundary;
distributing the icons on or within the boundary or on the determined tracks; and
recording and storing the angles of each of the determined tracks against the horizontal position of the interface as displayed via the external display unit, and the coordinates of the boundary and those of the icons.

For example, when the stereoscopic menu is shown as a sphere, its focus will be the centre of the sphere, and its boundary will be the circumference of the sphere's tangent circle which intersects with the centre of the sphere and runs parallel to the interface as displayed via the external display unit, and on the other hand; when the stereoscopic menu is shown as a cube, its focus will be the centre of the cube, and its boundary will be each of the cube's sides. The focus of the stereoscopic menu herein is not limited to any point on the interface as displayed via the external display unit; in the present embodiment of the invention, the focus should be the centre of the interface as displayed via the external display unit. Moreover, the focus and the boundary are transparent to the user, i.e., they do not show up on the interface that contains the stereoscopic menu.

Similarly, after the icons are distributed on or within the boundary or on a plurality of determined tracks, the embodiment of the invention also allows one more step in order to display the stereoscopic menu in a more visual manner: setting the attributes of the distributed icons comprising their sizes, colors, brightness and transparency, so that icons in different layers of the stereoscopic menu are differentiated. For example, icons visible to users in the stereoscopic menu can be differentiated from those invisible by assigning distinct attributes to them. It is preferable to make icons visible to users in the stereoscopic menu larger, brighter and less transparent than those invisible; furthermore, icons invisible to users in the stereoscopic menu can also be assigned more attributes in order to make them different from one another in different layers of the stereoscopic menu, thereby creating a more vivid stereoscopic graphics.

In Step S102, a moving track inputted by the user on the interface containing the stereoscopic menu and displayed by the external display unit is acquired.

In Step S103, based on coordinates of different acquired moving tack points, corresponding rotation tangent planes and rotation direction of the icons in the stereoscopic menu are determined. Based on different arithmetic methods, two or more points are allowed to be selected from the moving track. For example, when two points are selected, this step should rendered as: acquiring coordinates of any two points on the moving track inputted by the user on the interface that contains the stereoscopic menu as displayed via the external display unit. The moving coordinates acquired herein can be any two adjacent points, comprising the initial point as the user starts inputting and any one of its adjacent points, or the end point as the user stops inputting and any one of its adjacent points, amongst others, on the moving track inputted by the user on the interface that contains the stereoscopic menu as displayed via the external display unit. The present embodiment of the invention is intended to illustrate any different points on the moving track inputted by the user and not to limit the invention.

In the embodiment of the invention, this step should be rendered as:
determining the line on which coordinates of various points on the acquired moving track are located;
comparing it with coordinates of the stored boundary to identify the tangent plane which incorporates this line and runs vertical to the interface as displayed via the external display unit in the stereoscopic menu;
identifying a plurality of tangent planes which run parallel to the said tangent plane and incorporate each of the icons to set them as the rotation tangent planes of each icon based on coordinates of the stored icons; and
determining the rotation direction by sorting out the directions of the initial and end points among the two acquired different points.

In another embodiment of the invention, this step should be rendered as:
determining the angle of the line, on which coordinates of various points on the acquired moving track are located, against the horizontal position of the interface as displayed via the external display unit;
comparing this angle with a plurality of angles of each of the stored, determined tracks against the horizontal position of the interface as displayed via the external display unit to acquire the track which is located the most adjacent both to the angle against the horizontal position of the interface as displayed via the external display unit and to the angle against the said line and set it as the benchmark track on which the stereoscopic menu rotates;
comparing coordinates of the stored boundary with the benchmark track to find out the tangent plane which incorporates the benchmark track and runs vertical to the interface as displayed via the external display in the stereoscopic menu; and
identifying a plurality of tangent planes which run parallel to the said tangent plane and incorporate each of the icons based on coordinates of the stored icons, and then set them as the rotation tangent planes of each icon; determining the rotation direction by determining the directions of the initial and end points among the two acquired different points on the moving track.

Besides, the embodiments of the invention also allows one more step before, in or after Step S103 in order for the icons to rotate at different speed in line with the user's varying input speeds: determining the rotation speed of the icons in the stereoscopic menu pursuant to coordinates of various points on the moving track. This step comprises: identifying the time and distance required to move from the initial point to the end point among coordinates of various points on the moving track; calculating the rotation speed of the icons in the stereoscopic menu based on the resulted time and distance.

In Step S104, the icons in the stereoscopic menu are controlled to rotate in their determined, corresponding rotation tangent planes along the determined rotation direction.

In the embodiments of the invention, this step should be rendered as: controlling the icons in the stereoscopic menu to rotate at a constant speed in their determined, corresponding rotation tangent planes and at the preset initial speed along the determined rotation direction.

Moreover, when the rotation speed of the icons in the stereoscopic menu is determined, in the embodiments of the invention, this step is rendered as: controlling the icons in the stereoscopic menu to rotate in their determined, corresponding rotation tangent planes and at the determined rotation speed along the determined rotation direction, in order for the icons to rotate at different speed in line with the user's varying input speeds, thereby enabling a more user-friendly interface.

More steps can be incorporated after Step S104 in order to continue the rotation of the icons when the user stops inputting, comprising:
acquiring the current rotation speed of the icons when the user stops inputting the moving track and control them to continue rotating at this speed;
starting to record the rotation time of each icon once the user stops inputting the moving track, and when the time recorded reaches the preset limit, controlling the rotation speed of the icons to decrease the preset speed limit and driving them into inertial rotation at the decreased speed; and
repeating the foregoing operations, until the rotation speed of the icons reaches zero and the icons stop rotating.

The present embodiment of the invention can also comprise one more step after Step S104 as follows: detecting whether the rotation stopping signal inputted by the user is received, and if yes, controlling the rotating icons in the stereoscopic menu to stop rotating in line with this rotation stopping signal.

Another step that can be implemented after Step S104 is: detecting whether the recovery signal inputted by the user is received, and if yes, controlling the stereoscopic menu to recover its display in line with this icon recovery signal.

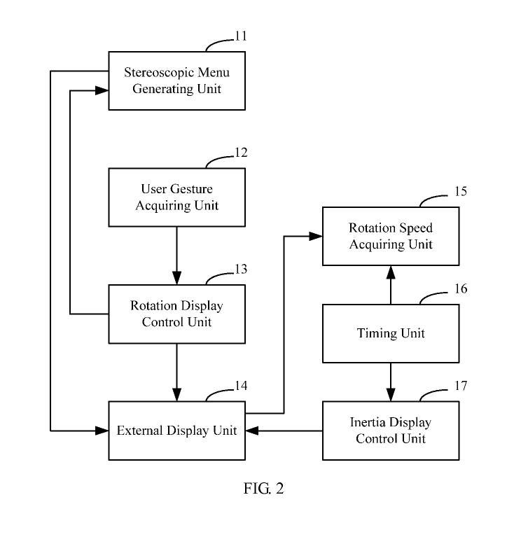

FIG. 2 illustrates the principles for implementing the system for controlling stereoscopic menu display as provided in the embodiment of the invention.

The Stereoscopic Menu Generating Unit 11 generates the stereoscopic menu that contains icons, and has it displayed via the External Display Unit 14. The icons herein can be images or words indicating specific functions; the stereoscopic menu that contains icons refers to some stereoscopic graphics that contains various menu icons indicating the basic functions provided by the primary interface, comprising spheres and other regular stereoscopic graphics. In the embodiments, the stereoscopic menu can also comprise icons provided by a plurality of secondary interfaces or lower level interfaces.

The User Gesture Acquiring Unit 12 acquires the moving track inputted by the user inputted on the interface that contains the stereoscopic menu as displayed via the External Display Unit 14. The Rotation Display Control Unit 13 determines the corresponding rotation tangent planes and rotation direction of the icons in the stereoscopic menu based on coordinates of various points on the moving track acquired by the User Gesture Acquiring Unit 12, and controls the icons in the stereoscopic menu to rotate in their determined, corresponding rotation tangent planes along the determined rotation direction. Based on different arithmetic methods, two or more points are allowed to be selected from the moving track. For example, when two points are selected, the User Gesture Acquiring Unit 12 acquires coordinates of any two points on the moving track inputted by the user on the interface that contains the stereoscopic menu as displayed via the External Display Unit 14. The mobile coordinates acquired herein can be any two adjacent points, comprising the initial point as the user starts inputting and any of its adjacent points, coupled with the end point for the user to stop inputting and any of its adjacent points, amongst others, on the moving track inputted by the user on the interface that contains the stereoscopic menu as displayed via the external display unit. The present embodiment of the invention is intended to illustrate any different point on the moving track inputted by the user and not to limit the invention.

Besides, the system for controlling menu display as provided in the present embodiment of the invention can also incorporate the Rotation Speed Acquiring Unit 15, the Timing Unit 16 and the Inertia Display Control Unit 17 in order to drive the icons into inertial rotation when the user stops inputting. The Rotation Speed Acquiring Unit 15 herein acquires the rotation speed of the icons as currently displayed via the External Display Unit 14 when the user stops inputting the moving track, and controls these icons to continue rotating at this rotation speed; the Timing Unit 16 records the rotation time of each icon once the user stops inputting the moving track; the Inertia Display Control Unit 17 controls the icons as displayed via the External Display Unit 14 to decrease the preset speed limit when the time recorded by the Timing Unit 16 reaches that limit, and drives them into inertial rotation at the decreased rotation speed.

The system for controlling stereoscopic menu display as provided in the present embodiment of the invention can also comprise the Stopping Signal Detection Unit and the Display Stopping Unit (not shown in the drawings). The Stopping Signal Detection Unit herein detects whether the rotation stopping signal that the user inputs through shortcut keys (comprising physical keys and touch keys) is received; the Display Stopping Unit controls the rotating icons in the stereoscopic menu as displayed via the External Display Unit 14 to stop rotating once the Stopping Signal Detection Unit detects and receives the rotation stopping signal inputted by the user.

Besides, the system for controlling menu display as provided in the present embodiment of the invention can also comprise the Recovery Signal Detection Unit and the Display Recovery Unit (not shown in the drawings). The Recovery Signal Detection Unit detects whether the icon recovery signal that the user inputs through shortcut keys (comprising physical keys and touch keys) is received; the Display Recovery Unit controls the icons as displayed via the External Display Unit 14 to recover their display once the Recovery Signal Detection Unit detects and receives the icon recovery signal inputted by the user.

The present embodiment of the invention also provides a mobile communication terminal, comprising a system and touch screen for controlling stereoscopic menu display, and the said system for controlling stereoscopic menu display is the same as the foregoing.

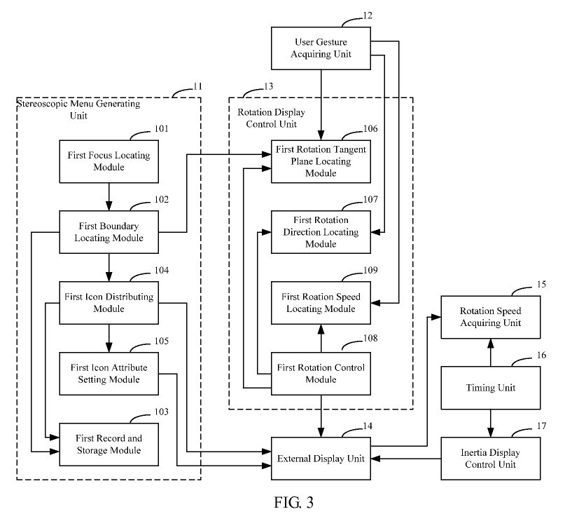

FIG. 3 illustrates the structure of FIG. 2 as provided in the embodiment of the invention.

The First Focus Locating Module 101 in the Stereoscopic Menu Generating Unit 11 locates the focus of the stereoscopic menu; the First Boundary Locating Module 102 in the Stereoscopic Menu Generating Unit 11 specifies the boundary of the stereoscopic menu with the focus located by the First Focus Locating Module 101 being the centre, so that the First Record and Storage Module 103 in the Stereoscopic Menu Generating Unit 11 records and stores the position of the boundary specified by the First Boundary Locating Module 102; the First Icon Distributing Module 104 in the Stereoscopic Menu Generating Unit 11 distributes the icons on or within the boundary specified by the First Boundary Locating Module 102, so that the First Record and Storage Module 103 records and stores coordinates of the icons distributed by the First Icon Distributing Module 104. The External Display Unit 14 displays the interface that contains the stereoscopic menu after the icons are distributed by the First Icon Distributing Module 104. The focus of the stereoscopic menu herein is not limited to any point on the interface as displayed via the external display unit, whereas in this embodiment of the invention, the focus should be the centre of the interface as displayed via the external display unit. Moreover, the focus and the boundary are transparent to the user, namely, they do not show up on the interface that contains the stereoscopic menu.

To display the stereoscopic menu in a more visual manner, in the present embodiment of the invention, the Stereoscopic Menu Generating Unit 11 also incorporates the First Icon Attribute Setting Module 105, which is configured to set the attributes of the icons distributed by the First Icon Distributing Module 104, comprising their sizes, colors, brightness or transparency, so that icons in different layers of the stereoscopic menu are differentiated, thereby. For example, icons visible to users in the stereoscopic menu can be differentiated from those invisible by assigning distinct attributes to them. It is preferable to make icons visible to users in the stereoscopic menu larger, brighter and less transparent than those invisible; furthermore, icons invisible to users in the stereoscopic menu can also be assigned more attributes in order to make them different from one another in different layers of the stereoscopic menu, thereby creating a more vivid stereoscopic graphics.

The User Gesture Acquiring Unit 12 acquires the moving track inputted by the user on the interface that contains the stereoscopic menu as displayed via the external display unit, and transmits it to the First Rotation Tangent Plane Locating Module 106 and the First Rotation Direction Locating Module 107 in the Rotation Display Control Unit 13. The First Rotation Tangent Plane Locating Module 106 determines the line on which coordinates of various points on the moving track acquired by the User Gesture Acquiring Unit 12 are located, and compares it with the coordinates of the boundary as stored in the First Record and Storage Module 103 to identify the tangent plane which incorporates this line and runs vertical to the interface as displayed via the external display unit, and then based on coordinates of the icons as stored by the First Record and Storage Module 103, determines a plurality of tangent planes which run parallel to the said tangent plane and incorporate each of the icons so as to set them as the rotation tangent planes of each icon. The First Rotation Direction Locating Module 107 determines the rotation direction by identifying directions of the initial and end points among the coordinates of various points on the moving track acquired by the User Gesture Acquiring Unit 12.

The First Rotation Control Module 108 in the Rotation Display Control Unit 13 controls the icons in the stereoscopic menu as displayed via the External Display Unit 14 to rotate in their corresponding rotation tangent planes as determined by the First Rotation Tangent Plane Locating Module 106 along the rotation direction determined by the First Rotation Direction Locating Module 107. Specifically, the First Rotation Control Module 108 controls the icons in the stereoscopic menu to rotate at a constant speed in their corresponding rotation tangent planes as determined by the First Rotation Tangent Plane Locating Module 106 and at the preset initial speed along the rotation direction determined by the First Rotation Direction Locating Module 107.

Moreover, for the icons to rotate at different rates in line with the user's varying input speeds, the Rotation Display Control Unit 13 can also incorporate the First Rotation Speed Locating Module 109, which is configured to determine the rotation speed of the icons in the stereoscopic menu based on the coordinates of various points on the moving track as acquired by the User Gesture Acquiring Unit 12. In this case, the First Rotation Control Module 108 is specifically configured to control the icons in the stereoscopic menu as displayed via the external display unit 14 to rotate in their corresponding rotation tangent planes as determined by the First Rotation Tangent Plane Locating Module 106 and at the rotation speed as identified by the First Rotation Speed Locating Module 109 along the rotation direction specified by the First Rotation Direction Locating Module 107 to endow the icons with the ability of rotating at different rates in line with the user's varying inputting speed, thereby enabling a more user-friendly interface.

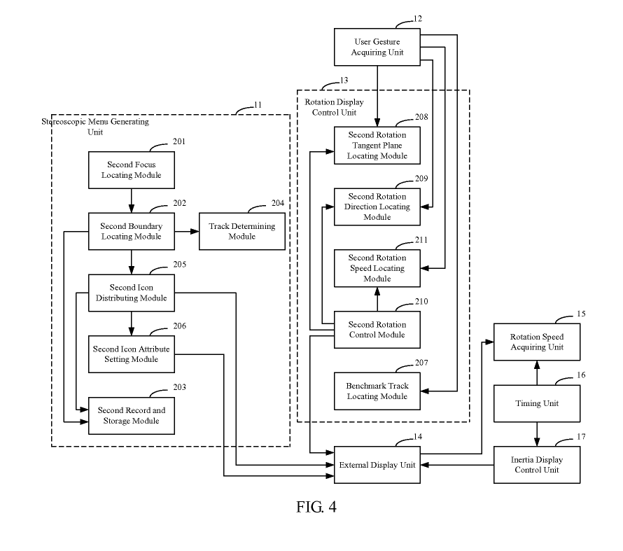

FIG. 4 illustrates the structure of FIG. 2 as provided in another embodiment of the invention.

The Second Focus Locating Module 201 in the Stereoscopic Menu Generating Unit 11 locates the focus of the stereoscopic menu; the Second Boundary Locating Module 202 in the Stereoscopic Menu Generating Unit 11 specifies the boundary of the stereoscopic menu with the focus located by the Second Focus Locating Module 201 being its centre, so that the Second Record and Storage Module 203 in the Stereoscopic Menu Generating Unit 11 records and stores the position of the boundary as specified by the Second Boundary Locating Module 202; the Track Determining Module 204 in the Stereoscopic Menu Generating Unit 11 determines a plurality of tracks, which may run parallel or vertical to or intersect with one another, within the boundary specified by the Second Focus Locating Module 201; the Second Icon Distributing Module 205 in the Stereoscopic Menu Generating Unit 11 distributes the icons on the boundary as specified by the Second Boundary Locating Module 202 and/or on a plurality of tracks as determined by the Track Determining Module 204, so that the Second Record and Storage Module 203 records and stores the angles of each of the tracks as determined by the Track Determining Module 204 against the horizontal position of the interface as displayed via the external display unit, the coordinates of the boundary as determined by the Second Boundary Locating Module 202, and the coordinates of the icons as distributed by the Second Icon Distributing Module 205. The External Display Unit 14 displays the interface that contains the stereoscopic menu after the icons are distributed by the Second Icon Distributing Module 205. The focus of the stereoscopic menu herein is not limited to any point on the interface as displayed via the external display unit, whereas in this embodiment of the invention, the focus should be the centre of the interface as displayed via the external display unit. Moreover, the focus and the boundary are transparent to the user, i.e., they do not show up on the interface that contains the stereoscopic menu.

To display the stereoscopic menu in a more visual manner, in the present embodiment of the invention, the Stereoscopic Menu Generating Unit 11 also incorporates the Second Icon Attribute Setting Module 206, which is configured to set the attributes of the icons distributed by the Second Icon Distributing Module 205, comprising their sizes, colors, brightness or transparency, so that icons in different layers of the stereoscopic menu are differentiated. For example, icons visible to users in the stereoscopic menu can be differentiated from those invisible by assigning distinct attributes to them. It is preferable to make icons visible to users in the stereoscopic menu larger, brighter and less transparent than those invisible; furthermore, icons invisible to users in the stereoscopic menu can also be assigned more attributes in order to make them different from one another in different layers of the stereoscopic menu, thereby creating a more vivid stereoscopic graphics.

The User Gesture Acquiring Unit 12 acquires the moving track inputted by the user on the interface that contains the stereoscopic menu as displayed via the external display unit, and transmits it to the Benchmark Track Locating Module 207, the Second Rotation Tangent Plane Locating Module 208 and the Second Rotation Direction Locating Module 209 in the Rotation Display Control Unit 13. The Benchmark Track Locating Module 207 determines the angle of the line, on which coordinates of various points on the moving track acquired by the User Gesture Acquiring Unit 12 are located, against the horizontal position of the interface as displayed via the external display unit 14, and compares this angle with a plurality of angles of each of the determined tracks, which are stored by the Second Record and Storage Module 203, against the horizontal position of the interface as displayed via the external display unit 14 to obtain the track which is located the most adjacent both to the angle against the horizontal position of the interface as displayed via the External Display Unit 14 and to the angle against the said line, and set this track as the benchmark track on which the stereoscopic menu rotates; the Second Rotation Tangent Plane Locating Module 208 determines the tangent plane which incorporates the benchmark track and runs vertical to the interface as displayed via the external display in the stereoscopic menu by comparing coordinates of the boundary specified by the Second Record and Storage Module 203 with the benchmark track located by the Benchmark Track Locating Module 207, and based on coordinates of the icons stored in the Second Record and Storage Module 203, identifies a plurality of tangent planes which incorporate each of the icons and run parallel to the said tangent plane in order to set them as the rotation tangent planes of individual icons; the Second Rotation Direction Locating Module 209 determines the rotation direction by determining the directions of the initial and end points among various points on the moving track acquired by the User Gesture Acquiring Unit 12.

The Second Rotation Control Module 210 in the Rotation Display Control Unit 13 controls the icons in the stereoscopic menu to rotate in their corresponding rotation tangent planes as determined by the Second Rotation Tangent Plane Locating Module 208 along the direction determined by the Second Rotation Direction Locating Module 209. Specifically, the Second Rotation Control Module 210 controls the icons in the stereoscopic menu to rotate at a constant speed in their corresponding rotation tangent planes as determined by the Second Rotation Tangent Plane Locating Module 208 and at the preset initial speed along the rotation direction determined by the Second Rotation Direction Locating Module 209.

Moreover, for the icons to rotate at different rates in line with the user's varying input speeds, the Rotation Display Control Unit 13 can also incorporate the Second Rotation Speed Locating Module 211, which is configured to determine the rotation speed of the icons in the stereoscopic menu based on coordinates of various points on the moving track as acquired by the User Gesture Acquiring Unit 12. In this case, the Second Rotation Control Module 210 is specifically configured to control icons in the stereoscopic menu to rotate in their corresponding rotation tangent planes as determined by the Second Rotation Tangent Plane Locating Module 208 and at the rotation speed as identified by the Second Rotation Speed Locating Module 211 along the rotation direction specified by the Second Rotation Direction Locating Module 209 for the icons to rotate at different rates in line with the user's varying input speeds, thereby enabling a more user-friendly interface.

In the present embodiment of the invention, based on the moving track inputted by the user on the interface that contains the stereoscopic menu as displayed via the external display unit, the rotation tangent planes and rotation direction of the icons in the stereoscopic menu are determined and the icons in the stereoscopic menu are controlled to rotate in their determined, corresponding rotation tangent planes along the determined rotation direction, thereby enabling a flexible, diversified and fun interface display; the stereoscopic menu can also present a more vivid tone by setting the attributes of the icons in it; and, the icons can be enabled to rotate according to the user's varying input speeds by determining the rotation speed, thereby offering a more user-friendly interface.

It is understandable to those skilled in the art that all or part of the steps in the foregoing embodiments may be performed through hardware instructed by a program. The said program may be stored in a computer-readable storage medium such as ROM/RAM, magnetic disk, and compact disk.

Described above are only exemplary embodiments of the present invention and are not intended to limit the invention. Any modification, replacement or improvement without departing from the spirit and scope of the invention shall all fall within the scope of protection covered by the present invention.

1. A method for controlling stereoscopic menu display, comprising:
generating and displaying a stereoscopic menu containing icons;
acquiring a moving track inputted by a user on an interface that contains the stereoscopic menu;
determining rotation tangent planes and a rotation direction of the icons in the stereoscopic menu based on coordinates of at least two points on the moving track; and
controlling the icons in the stereoscopic menu to rotate in their corresponding rotation tangent planes along the said rotation direction.

2. A method for controlling stereoscopic menu display as set forth in claim 1 wherein generating the stereoscopic menu that contains icons further includes:
determining a focus of the stereoscopic menu;
determining a boundary of the stereoscopic menu with the focus being the center of the boundary, and distributing the icons on or within the boundary; and
recording and storing coordinates of the boundary and coordinates of the distributed icons.

3. A method for controlling stereoscopic menu display as defined in claim 2, wherein determining the rotation tangent planes and rotation direction of the icons in the stereoscopic menu are determined based on coordinates of at least two points on the moving track further includes:
determining a line on which coordinates of at least two points on the moving track are located;
comparing the coordinates of the stored boundary with the line on which coordinates of at least two points are located to determine a tangent plane which incorporates the said line and runs vertical to the interface as displayed in the stereoscopic menu by the external display unit;
specifying a plurality of tangent planes that incorporate each of the icons and run parallel to the tangent plane as the corresponding rotation tangent planes of the icons in the stereoscopic menu based on coordinates of the stored icons; and
determining the rotation direction by identifying directions of the initial and end points among coordinates of at least two points on the acquired moving track.

4. A method for controlling stereoscopic menu display as set forth in claim 1, wherein generating the stereoscopic menu that contains icons further includes:
locating a focus of the stereoscopic menu;
specifying a boundary of the stereoscopic menu with the said focus being the centre of the boundary;
determining a plurality of tracks within the boundary;
distributing the icons on or within the boundary or on the tracks; and
recording and storing angles of the tracks against a horizontal position of the interface as displayed via the external display unit, corresponding to coordinates of the boundary and coordinates of the icons.

5. A method for controlling stereoscopic menu display as defined in claim 4, wherein determining the rotation tangent planes and rotation direction of the icons in the stereoscopic menu are determined based on coordinates of at least two points on the moving track further includes:
determining an angle of a line, on which coordinates of at least two points on the moving track are located, against the horizontal position of the interface as displayed via the external display unit;
comparing the determined angle against the line with angles of the stored, located tracks against the horizontal position of the interface as displayed via the external unit to obtain the track which is located the most adjacent both to the angle against the horizontal position of the interface as displayed via the external unit and to the angle against the line, and set this track as a benchmark track on which the stereoscopic menu rotates;
determining the tangent plane that incorporates the benchmark track and runs vertical to the interface as displayed via the external display unit in the stereoscopic menu by comparing coordinates of the stored boundary and coordinates of the benchmark track;
specifying a plurality of tangent planes that incorporate the icons and run parallel to the tangent plane as the corresponding rotation tangent planes of the icons in the stereoscopic menu based on coordinates of the stored icons; and
determining the rotation direction by identifying directions of the initial and end points among coordinates of two different points.

6. A method for controlling stereoscopic menu display as defined in claim 1, wherein controlling the icons in the stereoscopic menu rotate in their corresponding rotation tangent planes along the said rotation direction, respectively, further includes:
determining time and distance required to move from an initial point to an end point among coordinates of at least two points on the acquired moving track;
calculating a rotation speed of the icons in the stereoscopic menu based on the time and distance; and
controlling the icons in the stereoscopic menu to rotate in their corresponding rotation tangent planes and at the rotation speed along the said rotation direction;
or,
controlling the icons in the stereoscopic menu to rotate at a constant speed in their corresponding rotation tangent planes and at a preset initial speed along the rotation direction.

7. A method for controlling stereoscopic menu display as set forth in claim 6, the method further comprising:
Acquiring the rotation speed of the current icons and controlling each icon to continue rotating at the rotation speed when the user stops inputting the moving track; and
Starting to record the rotation time of each icon when the user stops inputting the moving track, controlling the rotation speed of the icons to decrease by a preset speed limit when the time recorded reaches a preset value, and then driving these icons into inertial rotation at the decreased rotation speed.

8. A method for controlling stereoscopic menu display as set forth in claim 6, the method further comprising:
detecting whether a recovery signal inputted by the user is received, and if yes, controlling the stereoscopic menu to recover its display according to the recovery signal; and
detecting whether a rotation stopping signal inputted by the user is received, and if yes, controlling the rotating icons in the stereoscopic menu to stop rotating in compliance with the rotation stopping signal.

9. A system for controlling stereoscopic menu display, comprising:
a Stereoscopic Menu Generating Unit configured to generate a stereoscopic menu containing icons and having the stereoscopic menu displayed via an external display unit;
a User Gesture Acquiring Unit configured to acquire a moving track inputted by a user on an interface that contains the stereoscopic menu generated by the Stereoscopic Menu Generating Unit; and
a Rotation Display Control Unit, configured to determine rotation tangent planes and a rotation direction of the icons in the stereoscopic menu generated by the Stereoscopic Menu Generating Unit according to coordinates of at least two points on the moving track acquired by the User Gesture Acquiring Unit, and used to control the icons in the stereoscopic menu as displayed via the external display unit to rotate in the determined, corresponding rotation tangent planes along the said rotation direction of the icons.

10. A system for controlling stereoscopic menu display as set forth in claim 9, further comprising:
A rotation Speed Acquiring Unit configured to acquire a rotation speed of the icons as currently displayed via the external display unit when the user stops inputting the moving track;
a Timing Unit for Starting to record rotation time of each icon as displayed via the external display unit when the user stops inputting the moving track; and
an Inertia Display Control Unit, configured to control the icons as displayed via the external display unit to decrease their rotation speed when the time recorded by the Timing Unit reaches the preset value, and then driving them into inertial rotation at the decreased speed.

11. A system for controlling stereoscopic menu display as set forth in claim 9, further comprising:
a Recovery Signal Detection Unit for detecting whether an icon recovery signal inputted by the user is received; and
a Display Recovery Unit for controlling the stereoscopic menu to recover its display once the Recovery Signal Detection Unit detects and receives the icon recovery signal inputted by the user.

12. A system for controlling stereoscopic menu display as set forth in claim 9, further comprising:
a Stopping Signal Detection Unit for detecting whether a rotation stopping signal inputted by the user is received; and
a Display Stopping Unit for controlling the rotating icons in the stereoscopic menu to stop rotating once the Stopping Signal Detection Unit detects and receives the rotation stopping signal inputted by the user.

13. A system for controlling stereoscopic menu display as set forth in claim 9, wherein the Stereoscopic Menu Generating Unit further comprises:
a First Focus Locating Module for locating a focus of the stereoscopic menu;
a First Boundary Locating Module for specifying a boundary of the stereoscopic menu with the focus as located by the First Focus Locating Module being the centre;
a First Icon Distributing Module for distributing the icons on or within the boundary specified by the First Boundary Locating Module, and for displaying the interface that contains the stereoscopic menu via the external display unit after the icons are distributed; and
a First Record and Storage Module for recording and storing a position of the boundary specified by the First Boundary Locating Module and coordinates of the icons distributed by the First Icon Distributing Module.

14. A system for controlling stereoscopic menu display as set forth in claim 13, wherein the Rotation Display Control Unit further comprises:
a First Rotation Tangent Plane Locating Module, which is configured to determine a line on which coordinates of at least two points on the moving track acquired by the Coordinates Acquiring Unit are located, and compare the line with the coordinates of the boundary as stored in the First Record and Storage Module to identify a tangent plane which incorporates this line and runs vertical to the interface as displayed via the external display unit, and to find out a plurality of tangent planes, which incorporate the icons and run parallel to the said tangent plane, in the stereoscopic menu and set them as the rotation tangent planes of the icons;
a First Rotation Direction Locating Module, which is configured to determine a rotation direction by acquiring directions of the initial and end points among coordinates of various points on the moving track acquired by the Coordinate Acquiring Unit;
a First Rotation Speed Locating Module, which is configured to determine a rotation speed of the icons in the stereoscopic menu based on coordinates of various points on the moving track acquired by the Coordinate Acquiring Unit; and
a First Rotation Control Module for controlling the icons in the stereoscopic menu as displayed via the external display unit to rotate in their corresponding rotation tangent planes as determined by the First Rotation Tangent Plane Locating Module and at the rotation speed as determined by the First Rotation Speed Locating Module along the rotation direction determined by the First Rotation Direction Locating Module.

15. A system for controlling stereoscopic menu display as set forth in claim 9, wherein the Stereoscopic Menu Generating Unit further comprises:
a Second Focus Locating Module for locating a focus of the stereoscopic menu;
a Second Boundary Locating Module for specifying a boundary of the stereoscopic menu with the focus as located by the Second Focus Locating Module being the centre;
a Track Determining Module for determining a plurality of tracks within the boundary as specified by the Second Focus Locating Module;
an Icon Distributing Module for distributing the icons on the boundary as specified by the Second Boundary Locating Module and/or on the plurality of tracks as determined by the Track Determining Module; and
a Second Record and Storage Module for recording and storing a position of the boundary as specified by the Second Boundary Locating Module, angles of the tracks as determined by the Track Determining Module against the horizontal position of the interface as displayed via the external display unit, and the coordinates of the icons as distributed by the Second Icon Distributing Module.

16. A system for controlling stereoscopic menu display as set forth in claim 15, wherein the Rotation Display Control Unit further comprises:
a Benchmark Track Locating Module, which is configured to determine an angle of the line, on which coordinates of at least two points on the moving track as acquired by the Coordinates Acquiring Unit are located, against the horizontal position of the interface as displayed via the external unit, and compare the angle of the line with the angles of the tracks as stored by the Second Record and Storage Module against the horizontal position of the interface as displayed via the external unit to acquire a track which is located the most adjacent both to the angle against the horizontal position of the interface as displayed via the external unit and to the angle against the line, and set the track as the benchmark track on which the stereoscopic menu rotates;
a Second Rotation Tangent Plane Locating Module, which is configured to compare the coordinates of the boundary as stored in the Second Record and Storage Module with the benchmark track as determined by the Benchmark Track Locating Module to find out a tangent plane which incorporates the benchmark track and runs vertical to the interface as displayed via the external display unit in the stereoscopic menu, and to identify a plurality of tangent planes which incorporate the icons and run parallel to the said tangent plane and set them as the rotation tangent planes for the icons;
a Second Rotation Direction Locating Module, which is configured to determine the rotation direction by acquiring directions of the initial and end points among the coordinates of at least two points on the moving track as acquired by the Coordinate Acquiring Unit;
a Second Rotation Speed Locating Module, which is configured to determine the rotation speed of the icons in the stereoscopic menu based on coordinates of at least two points on the moving track as acquired by the Coordinate Acquiring Unit; and
a Second Rotation Control Module, which is configured to control the icons in the stereoscopic menu as displayed via the external display unit to rotate in their corresponding rotation tangent planes as determined by the Second Rotation Tangent Plane Locating Module and at the rotation speed as determined by the Second Rotation Speed Locating Module along the rotation direction determined by the Second Rotation Direction Locating Module.

17. A mobile communication terminal, comprising a system for controlling stereoscopic menu display as set forth in claim 9 and touch screen.

18. A mobile communication terminal, comprising a system for controlling stereoscopic menu display as set forth in claim 10 and touch screen.

19. A mobile communication terminal, comprising a system for controlling stereoscopic menu display as set forth in claim 11 and touch screen.

20. A mobile communication terminal, comprising a system for controlling stereoscopic menu display as set forth in claim 12 and touch screen.
